(19) United States
(12) Patent Application Publication
(10) Pub. No.: US 2023/0135650 A1
(43) Pub. Date: May 4, 2023

(54) NEGATIVE ACTIVE MATERIAL COMPOSITE FOR RECHARGEABLE LITHIUM BATTERY, METHOD OF PREPARING THE SAME, NEGATIVE ELECTRODE INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Young-Min KIM, Yongin-si (KR); Eunji KANG, Yongin-si (KR); Youngugk KIM, Yongin-si (KR); Yookyung KIM, Yongin-si (KR); Sunil PARK, Yongin-si (KR); Changsu SHIN, Yongin-si (KR); Doori OH, Yongin-si (KR); Jongmin WON, Yongin-si (KR); Dae-Hyeok LEE, Yongin-si (KR); Jungho LEE, Yongin-si (KR)

(21) Appl. No.: 17/944,630

(22) Filed: Sep. 14, 2022

(30) Foreign Application Priority Data
Nov. 2, 2021 (KR) 10-2021-0148941

(51) Int. Cl. H01M 4/36; H01M 10/0525; H01M 4/133; H01M 4/134; H01M 4/38; H01M 4/48; H01M 4/587; H01M 4/04

(52) U.S. Cl. CPC H01M 4/364; H01M 10/0525; H01M 4/133; H01M 4/134; H01M 4/366; H01M 4/386; H01M 4/483; H01M 4/587; H01M 4/0433; H01M 4/0471; H01M 2004/021

(57) ABSTRACT

A negative active material composite, a method of preparing the same, and a negative electrode and a rechargeable lithium battery including the same, the negative active material composite including compound particles represented by SiOₓ, in which 0<x≤2.0; silicon nanoparticles having an average particle diameter (D50) of greater than 0 nm and less than or equal to about 200 nm; and amorphous carbon, wherein an internal pore volume of the negative active material composite is greater than 0 cm³/g and less than or equal to about 5.0×10⁻² cm³/g.

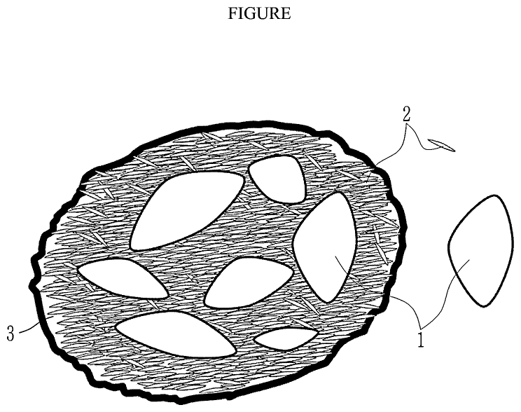

### CROSS-REFERENCE TO RELATED APPLICATION

This application claims priority to and the benefit of Korean Patent Application No. 10-2021-0148941 filed in the Korean Intellectual Property Office on Nov. 2, 2021, the entire contents of which are incorporated herein by reference.

### BACKGROUND

### 1. Field

Embodiments relate to a negative active material composite, a method of preparing the same, a negative electrode including the same, and a rechargeable lithium battery are disclosed.

### 2. Description of the Related Art

Rechargeable lithium batteries are in the spotlight as power sources for driving medium to large devices such as hybrid vehicles and battery vehicles as well as small devices such as mobile phones, notebook computers, and smart phones.

As a negative active material for a rechargeable lithium battery, various types of carbon negative active materials including artificial graphite, natural graphite, hard carbon, or the like, capable of intercalating/deintercalating lithium ions may be used. Recently, research on non-carbon negative active materials such as silicon and tin to obtain higher capacity has been considered.

### SUMMARY

The embodiments may be realized by providing a negative active material composite for a rechargeable lithium battery, the negative active material composite including compound particles represented by SiOₓ, in which 0<x≤2.0; silicon nanoparticles having an average particle diameter (D50) of greater than 0 nm and less than or equal to about 200 nm; and amorphous carbon, wherein an internal pore volume of the negative active material composite is greater than 0 cm³/g and less than or equal to about 5.0×10⁻² cm³/g.

The average particle diameter (D50) of the silicon nanoparticles may be about 50 nm to about 200 nm.

An aspect ratio of the silicon nanoparticles may be about 4 to about 20.

A full width at half maximum of an X-ray diffraction angle (2θ) using CuKα ray at the (111) plane of the silicon nanoparticles may be about 0.3° to about 1.5°.

An average particle diameter (D50) of the compound particles may be about 1 μm to about 10 μm.

The amorphous carbon may include soft carbon, hard carbon, a mesophase pitch carbonized product, calcined coke, or a combination thereof.

The composite may include the compound particles and the silicon nanoparticles in a weight ratio of about 8:2 to about 2:8.

The negative active material composite may include the compound particles in an amount of about 5 wt % to about 90 wt %, the silicon nanoparticles in an amount of about 10 wt % to about 95 wt %, and a balance amount of the amorphous carbon, all wt % being based on a total weight of the negative active material composite.

An average particle diameter (D50) of the negative active material composite may be about 2 μm to about 15 μm.

An internal pore diameter of the negative active material composite may be greater than 0 nm and less than or equal to about 200 nm.

A BET specific surface area of the negative active material composite may be about 0.1 m²/g to about 10 m²/g.

The negative active material composite may include a matrix including the silicon nanoparticles and the amorphous carbon; and the compound particles may be in the matrix.

The matrix may include secondary particles in which the silicon nanoparticles are aggregated; and a coating layer surrounding the outer surface of the secondary particle and the outer surface of the silicon nanoparticles and including the amorphous carbon.

The embodiments may be realized by providing a method of preparing the negative active material composite for a rechargeable lithium battery according to an embodiment, the method including spray-drying a solution including a solvent, the compound particles represented by SiOₓ, in which 0<x≤2.0, and the silicon nanoparticles; compression-molding a mixture including the obtained product of the spray-drying and the amorphous carbon precursor at a pressure of greater than about 10 Mpa; and heat-treating the obtained product of the compression-molding to obtain the negative active material composite.

The spray-drying may be performed at a temperature of about 120° C. to about 170° C.

The compression-molding may be performed at a pressure of about 10 MPa to about 150 MPa.

The heat-treating may be performed at a temperature of about 700° C. to about 1,100° C.

The embodiments may be realized by providing a negative electrode for a rechargeable lithium battery, the negative electrode including a current collector; and a negative active material layer on the current collector, wherein the negative active material layer includes the negative active material composite according to an embodiment.

The negative active material layer may further include a conductive material, a binder, or a combination thereof.

The embodiments may be realized by providing a rechargeable lithium battery including a positive electrode; a negative electrode; and an electrolyte, wherein the negative electrode is the negative electrode according to an embodiment.

### BRIEF DESCRIPTION OF THE DRAWING

Features will be apparent to those of skill in the art by describing in detail exemplary embodiments with reference to the attached drawing in which:

the FIGURE is a schematic view of the negative active material composite according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figure, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout. As used herein, the term “or” is not an exclusive term, e.g., “A or B” would include A, B, or A and B.

The terminology used herein is used to describe embodiments only, and is not intended to limit the present disclosure. The singular expression includes the plural expression unless the context clearly dictates otherwise.

As used herein, “a combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In addition, “layer” herein includes not only a shape formed on the whole surface when viewed from a plan view, but also a shape formed on a partial surface.

In addition, the “particle diameter” or “average particle diameter” may be measured by a suitable method, e.g., may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

“Thickness” may be measured through a picture taken with an optical microscope such as a scanning electron microscope.

(Negative Active Material)

In an implementation, a negative active material composite for a rechargeable lithium battery may include, e.g., compound particles represented by SiOₓ, in which 0<x≤2.0; silicon nanoparticles having an average particle diameter (D50) of greater than 0 nm and less than or equal to about 200 nm; and amorphous carbon. In an implementation, an internal pore volume (of the negative active material composite) may be, e.g., greater than 0 cm³/g and less than or equal to about 5.0×10⁻² cm³/g.

In some other negative active material composites, SiO (silicon monoxide), SiC (silicon carbide), and the like have been used in order to help suppress a volume change of a non-carbon negative active material (silicon, tin, or the like) as well as help improve low capacity of a carbon negative active material (artificial graphite, natural graphite, hard carbon, or the like) and thus help secure cycle-life characteristics.

Both the SiO and the SiC may help increase capacity of a rechargeable lithium battery, compared with a carbon negative active material. However, the SiO is a negative active material that has high resistance and needs to be used by making its size small, may a little lower initial efficiency of the rechargeable lithium battery but secure cycle-life characteristics; the SiC is a negative active material that increases initial efficiency of the rechargeable lithium battery but is somewhat disadvantageous in securing cycle-life characteristics. As such, the capacity of the rechargeable lithium battery has a trade-off relationship with the initial efficiency and cycle-life, which are very difficult to evenly increase.

The negative active material composite of an embodiment is a composite of compound particles 1 represented by SiOₓ (0<x≤2.0), silicon nanoparticles 2, and amorphous carbon 3, as shown in the FIGURE, which may help compensate for each disadvantage of the SiO and the SiC, while taking advantages thereof. Furthermore, the negative active material composite of an embodiment may have a specific surface area limited within an appropriate range by limiting a D50 particle diameter of the silicon nanoparticles within about 200 nm or less and simultaneously, limiting an internal pore volume of the composite of greater than 0 cm³/g and about 5.0×10⁻² cm³/g or less and thus may help secure initial efficiency and cycle-life of the rechargeable lithium battery at the same time.

Hereinafter, the negative active material composite of the embodiment is described in detail.

Silicon Nanoparticles

In the negative active material composite of the embodiment, the silicon nanoparticles may be a component contributing to increasing the capacity of the rechargeable lithium battery.

An average particle diameter (D50) of the silicon nanoparticles may be, e.g., greater than 0 nm and less than or equal to about 200 nm, and a maximum particle diameter (Dₘₐₓ) may be, e.g., greater than 0 nm and less than or equal to about 300 nm. In an implementation, the average particle diameter (D50) of the silicon nanoparticles may be greater than or equal to about 50 nm, greater than or equal to about 60 nm, greater than or equal to about 70 nm, or greater than or equal to about 80 nm, and less than or equal to about 200 nm, less than or equal to about 150 nm, less than or equal to about 140 nm, less than or equal to about 130 nm, or less than or equal to about 115 nm. In an implementation, the maximum particle diameter (Dₘₐₓ) of the silicon nanoparticles may be greater than or equal to about 80 nm, greater than or equal to about 90 nm, greater than or equal to about 100 nm, or greater than or equal to about 110 nm, and less than or equal to about 300 nm, less than or equal to about 250 nm, less than or equal to about 240 nm, less than or equal to about 230 nm, or less than or equal to about 215 nm. Within these ranges, the side reaction between the silicon nanoparticles and the electrolyte may be suppressed, and the expansion of the silicon nanoparticles may be reduced, thereby improving initial efficiency and cycle-life characteristics of the rechargeable lithium battery.

A short axis length (a) of the silicon nanoparticles may be, e.g., about 5 nm to about 50 nm, and a long axis length (b) of the silicon nanoparticles may be, e.g., about 50 nm to about 300 nm. An aspect ratio (b/a) of the silicon nanoparticles may be, e.g., about 4 to about 20. In an implementation, the aspect ratio of the silicon nanoparticles may be greater than or equal to about 4, greater than or equal to about 5, greater than or equal to about 6, or greater than or equal to about 7, and less than or equal to about 20, less than or equal to about 18, less than or equal to about 16, or less than or equal to about 14. When the long axis length (b), short axis length (a), and aspect ratio (b/a) of the silicon nanoparticles each fall within the above ranges, side reactions between the silicon nanoparticles and the electrolyte may be suppressed, and the expansion of the silicon nanoparticles may be reduced, so that initial efficiency and cycle-life characteristics of the rechargeable lithium battery may be improved.

A full width at half maximum of an X-ray diffraction angle (2 theta) using CuKα ray at the (111) plane of the silicon nanoparticles may be, e.g., about 0.3° to about 1.5°. Within this range, cycle-life characteristics of the rechargeable lithium battery may be improved. The full width at half maximum of the X-ray diffraction angle (2 theta) using CuKα ray at the (111) plane of the silicon nanoparticles may be achieved by adjusting the particle size of the silicon nanoparticles or changing the silicon nanoparticle preparing process.

Compound Particles Represented by SiOₓ (0<x≤2.0)

In the negative active material composite of the embodiment, the compound particles represented by SiOₓ (0<x≤2.0) are a component contributing to securing cycle-life characteristics of a rechargeable lithium battery.

The compound particles represented by SiOₓ (0<x≤2.0), e.g., SiO, SiO₂, etc. may be materials with high resistance, and the average particle diameter (D50) and the maximum particle diameter (Dₘₐₓ) of the compound particles may be reduced to lower a resistance when the negative electrode is applied. In an implementation, the average particle diameter (D50) of the compound particles represented by SiOₓ (0<x≤2.0) may be, e.g., about 1 μm to about 10 μm, and the maximum particle diameter (Dₘₐₓ) may be, e.g., about 5 μm to about 20 μm. In an implementation, the average particle diameter (D50) of the compound particles represented by SiOₓ (0<x≤2.0) may be greater than or equal to about 1 μm, greater than or equal to about 2 μm, greater than or equal to about 3 μm, or greater than or equal to about 4 μm, and less than or equal to about 10 μm, less than or equal to about 9 μm, less than or equal to about 8 μm, less than or equal to about 7 μm, or less than or equal to about 6 μm. In an implementation, the maximum particle diameter (Dₘₐₓ) of the compound particles represented by the SiOₓ (0<x≤2.0) may be greater than or equal to about 5 μm, greater than or equal to about 6 μm, greater than or equal to about 7 μm, or greater than or equal to about 8 μm and less than or equal to about 20 μm, less than or equal to about 18 μm, less than or equal to about 16 μm, less than or equal to about 14 μm, or less than or equal to about 12 μm. Within these ranges, the resistance of the compound particles represented by SiOₓ (0<x≤2.0) upon application of the negative electrode may be minimized.

Amorphous Carbon

In the negative active material composite of the embodiment, the amorphous carbon may surround the outer surface of the silicon nanoparticles, so that the conductivity of the negative active material may be further improved, and contacts between the silicon nanoparticles and the electrolyte may be suppressed to reduce side reactions between them, and cycle-life characteristics of the rechargeable lithium battery may be secured. In an implementation, the amorphous carbon may serve as a binder for binding the silicon nanoparticles to each other, thereby preventing the composite from breaking and maintaining its shape well.

The amorphous carbon may include, e.g., soft carbon, hard carbon, a mesophase pitch carbonized product, calcined coke, or a combination thereof. The amorphous carbon, in contrast to crystalline carbon, may effectively penetrate between silicon nanoparticles during the heat-treating process to reduce internal pores, thereby improving conductivity and effectively suppressing side reactions of the electrolyte.

Composite

As described above, the negative active material composite of an embodiment, through a composite of compound particles represented by SiOₓ (0<x≤2.0), silicon nanoparticles, and amorphous carbon, may help compensate for each disadvantage of SiO and SiC, while taking advantages thereof and thus secure initial efficiency and cycle-life of the rechargeable lithium battery at the same time.

The composite may include the compound particles represented by SiOₓ (0<x≤2.0) and the silicon nanoparticles in a weight ratio (SiOₓ:silicon) of about 8:2 to about 2:8, e.g., about 7:3 to about 3: 7, or about 6:4 to about 4:6. Within the above ranges, an effect of improving the capacity of the rechargeable lithium battery by the silicon nanoparticles and an effect of securing the cycle-life of the rechargeable lithium battery by the compound particles represented by SiOₓ (0<x≤2.0) may be harmonized.

In an implementation, based on the total weight of the negative active material composite, the compound particles represented by SiOₓ (0<x≤2.0) may be included in an amount of about 5 wt % to about 90 wt %, e.g., about 10 wt % to about 70 wt %, about 20 wt % to about 60 wt %, or about 30 wt % to about 50 wt %; the silicon nanoparticles may be included in an amount of about 10 wt % to about 95 wt %, e.g., about 20 wt % to about 75 wt %, about 20 wt % to about 60 wt %, or about 30 wt % to about 50 wt %. In an implementation, the amorphous carbon may be included in a balance amount. Within the above ranges, an effect of improving the capacity of the rechargeable lithium battery by the silicon nanoparticles, an effect of securing the cycle-life of the rechargeable lithium battery by the compound particles represented by the SiOₓ (0<x≤2.0), and the amorphous carbon may be harmonized.

The average particle diameter (D50) of the negative active material composite may be, e.g., about 2 μm to about 15 μm, and the maximum particle diameter (Dₘₐₓ) may be, e.g., about 5 μm to about 40 μm. In an implementation, the average particle diameter (D50) of the composite may be greater than or equal to about 2 μm, greater than or equal to about 3 μm, greater than or equal to about 4 μm, or greater than or equal to about 5 μm, and less than or equal to about 15 μm, less than or equal to about 14 μm, less than or equal to about 13 μm, less than or equal to about 12 μm, or less than or equal to about 11 μm. In an implementation, the maximum particle diameter (Dₘₐₓ) of the composite may be greater than or equal to about 5, greater than or equal to about 7 μm, greater than or equal to about 10 μm, greater than or equal to about 11 μm, greater than or equal to about 12 μm, or greater than or equal to about 13 μm, and less than or equal to about 40 μm, less than or equal to about 38 μm, less than or equal to about 36 μm, less than or equal to about 34 μm, or less than or equal to about 32 μm. Within these ranges, an excessive increase in the specific surface area of the negative active material composite may be suppressed to help reduce side reactions with the electrolyte, and to help improve rate capability while suppressing a resistance of the rechargeable lithium battery.

The inside of the negative active material composite may include pores having a diameter of, e.g., greater than 0 nm and less than or equal to about 330 nm, and a volume of the internal pores having the diameter may be greater than 0 cm³/g and less than or equal to about 5.0×10⁻² cm³/g. In an implementation, the diameter of the internal pore inside the negative active material composite may be greater than 0 nm, greater than or equal to about 10 nm, greater than or equal to about 20 nm, greater than or equal to about 30 nm, greater than or equal to about 40 nm, greater than or equal to about 50 nm, greater than or equal to about 60 nm, greater than or equal to about 70 nm, greater than or equal to about 80 nm, greater than or equal to about 90 nm, or greater than or equal to about 100 nm, and less than or equal to about 330 nm, 300 nm, less than or equal to about 250 nm, less than or equal to about 200 nm, less than or equal to about 180 nm, less than or equal to about 160 nm, less than or equal to about 140 nm, or less than or equal to about 120 nm. In an implementation, the volume of the internal pores having the above diameter may be greater than about 0 cm³/g, greater than or equal to about 0.1×10⁻² cm³/g, greater than or equal to about 0.2×10⁻² cm³/g, greater than or equal to about 0.3×10⁻² cm³/g, greater than or equal to about 0.4×10⁻² cm³/g, greater than or equal to about 0.5×10⁻² cm³/g, greater than or equal to about 0.6×10⁻² cm³/g, greater than or equal to about 0.8×10⁻² cm³/g, or greater than or equal to about 1.0×10⁻² cm³/g and less than or equal to about 5.0×10⁻² cm³/g, less than or equal to about 4.5×10⁻² cm³/g, less than or equal to about 4.0×10⁻² cm³/g, less than or equal to about 3.5×10⁻² cm³/g, or less than or equal to about 3.0×10⁻² cm³/g. When the diameter and volume of the internal pores inside the composite satisfy the aforementioned ranges, a side reaction between the silicon nanoparticles included in the composite and the electrolyte may be suppressed, and expansion of the silicon nanoparticles may be lowered, so that initial efficiency and cycle-life characteristics of the rechargeable lithium battery may be improved.

In an implementation, as described above, the volume of the internal pores having a diameter of nanometers (nm) may be quantitatively measured with a BJH (Barrett-Joyner-Halenda) analysis facility.

In an implementation, the BET specific surface area of the negative active material composite may be, e.g., about 0.1 cm²/g to about 10 cm²/g. In an implementation, the BET specific surface area of the composite may be greater than or equal to about 0.1 cm²/g, greater than or equal to about 0.5 cm²/g, greater than or equal to about 1 cm²/g, greater than or equal to about 1.5 cm²/g, greater than or equal to about 2 cm²/g, greater than or equal to about 2.5 cm²/g, or greater than or equal to about 3 cm²/g, and less than or equal to about 10 cm²/g, less than or equal to about 9 cm²/g, less than or equal to about 8 cm²/g, less than or equal to about 7 cm²/g, less than or equal to about 5 cm²/g, less than or equal to about 3 cm²/g, or less than or equal to about 2.5 cm²/g. Within these ranges, an excessive increase in the specific surface area of the negative active material composite may be suppressed to help reduce side reactions with the electrolyte, and to help improve rate capability while suppressing a resistance of the rechargeable lithium battery.

The negative active material composite may include a matrix including the silicon nanoparticles and the amorphous carbon; and the compound particles represented by SiOₓ (0<x≤2.0) may be (e.g., dispersed) in the matrix. In an implementation, the matrix may include secondary particles in which the silicon nanoparticles are aggregated; and a coating layer surrounding the outer surface of the secondary particle and the outer surface of the silicon nanoparticles and including the amorphous carbon. When achieving such a structure, while implementing an effect of improving capacity of the rechargeable lithium battery by the silicon nanoparticles and the effect of securing the cycle-life of the rechargeable lithium battery by the compound particles represented by SiOₓ (0<x≤2.0), the coating layer including the amorphous carbon may surround the outer surface of the secondary particles and the outer surface of the silicon nanoparticles to maintain a dense structure, thereby reducing side reactions with the electrolyte and further improving cycle-life of the rechargeable lithium battery.

The coating layer may have a thickness of about 1 nm to about 900 nm, e.g., about 5 nm to about 800 nm. Within these ranges, an internal pore size and a volume of the composite may be controlled, a degree of penetration of the electrolyte into the interior of the composite may be controlled, and a side reaction between the electrolyte and the negative active material composite may be minimized to improve cycle-life characteristics of the rechargeable lithium battery.

(Method of Preparing Negative Active Material)

In an implementation, a method of preparing a negative active material composite for a rechargeable lithium battery may include, e.g., spray-drying a solution including a solvent, compound particles represented by SiOₓ (0<x≤2.0), and silicon nanoparticles; compression-molding a mixture including the obtained product of the spray-drying and the amorphous carbon precursor at a pressure of greater than about 10 Mpa; and heat-treating the obtained product of the compression-molding.

Through the above series of processes, the negative active material composite of the aforementioned embodiment may be obtained. Hereinafter, descriptions overlapping with the above will be omitted and each process will be described.

Spray-Drying

First, in an embodiment, spray-drying the slurry including the solvent, compound particles represented by SiOₓ (0<x≤2.0), and silicon nanoparticles may be performed.

The solvent may be a suitable solvent capable of dispersing both the compound particles represented by SiOₓ (0<x≤2.0) and the silicon nanoparticles, e.g., isopropyl alcohol (IPA), ethanol (EtOH), or the like.

When preparing the solution or dispersion, a weight ratio of the compound particles represented by SiOₓ (0<x≤2.0) and the silicon nanoparticles (SiOₓ:silicon) may be controlled to be about 8:2 to about 2:8, e.g., about 7:3 to about 3:7, for or about 6:4 to about 4:6. Accordingly, the weight ratio of the compound particles represented by SiOₓ (0<x≤2.0) and the silicon nanoparticles in the obtained product of the spray-drying and the final product according to the embodiment may be determined.

The spray-drying may be performed at about 120° C. to about 170° C. using a spray dryer. The obtained product of the spray-drying may include secondary particles in which the silicon nanoparticles are aggregated; and compound particles inside the secondary particle and represented by the SiOₓ (0<x≤2.0).

Compression-Molding

In an implementation, the obtained product of the spray-drying may be mixed with an amorphous carbon precursor and compression-molded.

The amorphous carbon precursor may include, e.g., pitches such as a coal pitch or a petroleum pitch; resins such as a phenol resin or a furan resin; or hydrocarbons having 1 to 10 carbon atoms. In an implementation, the pitch may be used from the viewpoint of economy and the like.

The compression-molding may be performed at a pressure of about 10 MPa to about 150 MPa, e.g., about 15 MPa to about 150 MPa, or about 20 MPa to about 125 MPa. When the obtained product of the spray-drying is compressed within these ranges, the initial efficiency and cycle-life characteristics of the rechargeable lithium battery may be improved by appropriately maintaining gaps between the silicon nanoparticles and controlling a pore volume inside the obtained product of the compression-molding to suppress a side reaction of an electrolyte solution with the silicon nanoparticles.

The obtained product of the compression-molding may include a matrix precursor including the silicon nanoparticles and the amorphous carbon precursor; and the compound particles positioned inside the matrix precursor. In an implementation, the matrix precursor may include secondary particles in which the silicon nanoparticles are aggregated; and a coating layer surrounding the outer surface of the secondary particles and the outer surface of the silicon nanoparticles and including the amorphous carbon precursor.

Heat-Treating

In an implementation, the obtained product of the compression-molding may be heat-treated.

The heat treatment may be performed at about 700° C. to about 1,100° C., e.g., about 800° C. to about 1,050° C., or about 900° C. to about 1,000° C. Within these ranges, the amorphous carbon precursor in the obtained product of the spray-drying may be carbonized. Accordingly, the amorphous carbon precursor may be converted into amorphous carbon, and the obtained product of the compression-molding may be converted into the composite of one embodiment, improving strength, conductivity, and the like and thus initial efficiency of the rechargeable lithium battery.

In an implementation, the heat treatment may be performed in a furnace under a nitrogen (N₂) atmosphere.

(Negative Electrode)

In an implementation, a negative electrode for a rechargeable lithium battery may include a current collector and a negative active material layer on the current collector, wherein the negative active material layer includes the negative active material composite according to the aforementioned embodiment.

The negative electrode of the above embodiment may include the negative active material composite of the aforementioned embodiment, and capacity, efficiency, and cycle-life of the rechargeable lithium battery may be simultaneously secured. Hereinafter, repeated descriptions overlapping with the above may be omitted, and configurations other than the negative active material composite will be described.

Current Collector

The current collector may include, e.g., a copper foil, a nickel foil, a stainless steel foil, a titanium foil, a nickel foam, a copper foam, a polymer substrate coated with a conductive metal, or a combination thereof.

Negative Active Material Layer

The negative active material layer may include, e.g., the negative active material composite of the aforementioned embodiment. In an implementation, the negative active material layer may further include a negative active material different from the composite of the aforementioned embodiment.

The negative active material different from the composite of the aforementioned embodiment may include a material that reversibly intercalates/deintercalates lithium ions, lithium metal, lithium metal alloy, material being capable of doping and dedoping lithium, or a transition metal oxide.

The material that reversibly intercalates/deintercalates lithium ions may include, e.g., crystalline carbon, amorphous carbon, or a combination thereof as a carbon negative active material. The crystalline carbon may be non-shaped, or sheet, flake, spherical, or fiber shaped natural graphite or artificial graphite. The amorphous carbon may include a soft carbon, a hard carbon, a mesophase pitch carbonization product, calcined coke, or the like.

The lithium metal alloy may include an alloy of lithium and, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative active material or a Sn negative active material. The Si negative active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, or a combination thereof, but not Si) and the Sn negative active material may include Sn, SnO₂, Sn—R alloy (wherein R is an alkali metal, an alkaline-earth metal, a Group 13 element, a Group 14 element, a Group 15 element, a Group 16 element, a transition metal, a rare earth element, or a combination thereof, but not Sn). At least one of these materials may be mixed with SiO₂. The elements Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer disposed on the surface of the core. The crystalline carbon may include artificial graphite, natural graphite, or a combination thereof. The amorphous carbon precursor may include a coal pitch, mesophase pitch, petroleum pitch, coal oil, petroleum heavy oil, or a polymer resin such as a phenol resin, a furan resin, or a polyimide resin. In an implementation, the content of silicon may be about 10 wt % to about 50 wt % based on the total weight of the silicon-carbon composite. In an implementation, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In an implementation, a thickness of the amorphous carbon coating layer may be about 5 nm to about 100 nm. An average particle diameter (D50) of the silicon particles may be about 10 nm to about 20 pm. The average particle diameter (D50) of the silicon particles may be, e.g., about 10 nm to about 200 nm. The silicon particles may exist in an oxidized form, and in this case, an atomic content ratio of Si:O in the silicon particles indicating a degree of oxidation may be a weight ratio of about 99:1 to about 33:66. The silicon particles may be SiOₓ particles, and in this case, the range of x in SiOₓ may be greater than about 0 and less than about 2. As used herein, when a definition is not otherwise provided, an average particle diameter (D50) indicates a particle where an accumulated volume is about 50 volume % in a particle distribution.

The Si negative active material or Sn negative active material may be mixed with the carbon negative active material. When the Si negative active material or Sn negative active material and the carbon negative active material are mixed and used, the mixing ratio may be a weight ratio of about 1:99 to about 90:10.

In the negative active material layer, the negative active material may be included in an amount of about 95 wt % to about 99 wt % based on the total weight of the negative active material layer.

In an implementation, the negative active material layer may further include a binder. In an implementation, the negative active material layer may further include a conductive material. The content of the binder in the negative active material layer may be about 1 wt % to about 30 wt % based on the total weight of the negative active material layer. In an implementation, when the conductive material is further included, the negative active material layer may include about 50 wt % to about 98 wt % of the negative active material, about 1 wt % to about 30 wt % of the binder, and about 1 wt % to about 30 wt % of the conductive material.

The binder may serve to adhere the negative active material particles to each other well, and also to adhere the negative active material to the current collector well. The binder may include a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include, e.g., a styrene-butadiene rubber, an acrylated styrene-butadiene rubber, an acrylonitrile-butadiene rubber, an acrylic rubber, a butyl rubber, a fluororubber, or a combination thereof. The polymer resin binder may include, e.g., polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

When a water-soluble binder is used as the negative electrode binder, a cellulose compound capable of imparting viscosity may be further included. The cellulose compound may include carboxymethyl cellulose, hydroxypropylmethyl cellulose, methyl cellulose, or alkali metal salts thereof. The alkali metal may include, e.g., Na, K, or Li. The amount of such a thickener used may be about 0.1 parts by weight to about 3 parts by weight based on 100 parts by weight of the negative active material.

The conductive material may be included to provide electrode conductivity. A suitable electrically conductive material that does not cause a chemical change may be used as a conductive material. Examples of the conductive material may include a carbon material such as natural graphite, artificial graphite, carbon black, acetylene black, ketjen black, a carbon fiber, carbon nanotube, or the like; a metal material of a metal powder or a metal fiber including copper, nickel, aluminum silver, or the like; a conductive polymer such as a polyphenylene derivative; or a mixture thereof.

The negative current collector may include, e.g., a copper foil, a nickel foil, a stainless steel foil, a titanium foil, a nickel foam, a copper foam, a polymer substrate coated with a conductive metal, or a combination thereof.

(Rechargeable Lithium Battery)

In another embodiment, a rechargeable lithium battery may include a positive electrode; a negative electrode; and an electrolyte, wherein the negative electrode is the negative electrode of the aforementioned embodiment.

The rechargeable lithium battery of the embodiment may include the negative electrode of the aforementioned embodiment, and the capacity, efficiency, and cycle-life of the rechargeable lithium battery may be simultaneously secured. Hereinafter, descriptions overlapping with those described above may be omitted, and configurations other than the negative electrode will be described.

Positive Electrode

The positive electrode may include a current collector and a positive active material layer on the current collector. According to an embodiment, the positive electrode may have a structure in which a current collector, a positive active material layer, a functional layer, and an adhesive layer are stacked in this order.

The positive active material layer may include a positive active material, and may further include a binder and/or a conductive material.

The positive active material may include lithiated intercalation compounds that reversibly intercalate and deintercalate lithium ions. Examples of the positive active material may include a compound represented by any one of the following chemical formulas.

LiₐA_{1-b}X_{b}D₂(0.90≤a≤1.8, 0≤b≤0.5);

LiₐA_{1-b}X_{b}O_{2-c}D_{c}(0.90≤a≤1.8, 0≤b≤0.5, 0≤c≤0.05);

LiₐE_{1-b}X_{b}O_{2-c}(0.90≤a≤1.8, 0≤b≤0.5, 0≤c≤0.05);

LiₐE_{2-b}X_{b}O_{4-c}D_{c}(0.90≤a≤1.8, 0≤b≤0.5, 0≤c≤0.05);

LiₐN_{1-b-c}Co_{b}X_{c}D_{α}(0.90≤a≤1.8, 0≤b≤0.5, 0≤c≤0.5, 0<α≤2);

LiₐNi_{1-b-c}Co_{b}X_{c}O_{2-α}T_{α}(0.90≤a≤1.8, 0≤b≤0.5, 0≤c≤0.05, 0≤α≤2);

LiₐNi_{1-b-c}Co_{b}X_{c}O_{2-α}T₂(0.90≤a≤1.8, 0≤b≤0.5, 0≤c≤0.05, 0≤a≤2);

LiₐNi_{1-b-c}Mn_{b}X_{c}D_{α}(0.90≤a≤1.8, 0≤b≤0.5, 0≤c≤0.05, 0<α≤2);

LiₐNi_{1-b-c}Mn_{b}X_{c}O_{2-α}T_{α}(0.90≤a≤1.8, 0≤b≤0.5, 0≤c≤0.05, 0≤α≤2);

LiₐNi_{1-b-c}Mn_{b}X_{c}O_{2-α}T₂(0.90≤a≤1.8, 0≤b≤0.5, 0≤c≤0.05, 0≤α≤2);

LiₐNi_{b}E_{c}G_{d}O₂(0.90≤a≤1.8, 0≤b≤0.9, 0≤c≤0.5, 0.001≤d≤0.1);

LiₐNi_{b}Co_{c}Mn_{d}GₑO₂(0.90≤a≤1.8, 0≤b≤0.9, 0≤c≤0.5, 0≤d≤0.5, 0.001≤e≤0.1);

LiₐNiG_{b}O₂(0.90≤a≤1.8, 0.001≤b≤0.1);

LiₐCoG_{b}O₂(0.90≤a≤1.8, 0.001≤b≤0.1);

LiₐMn_{1-b}G_{b}O₂(0.90≤a≤1.8, 0.001≤b≤0.1);

LiₐMn₂G_{b}O₄(0.90≤a≤1.8, 0.001≤b≤0.1);

LiₐMn_{1-g}G_{g}PO₄(0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2); and

LiₐFePO₄(0.90≤a≤1.8).

In chemical formulae, A may be, e.g., Ni, Co, Mn, or a combination thereof; X may be, e.g., Al, Ni, Co, Mn, Cr, Fe, Mg, Sr, V, a rare earth element, or a combination thereof; D may be, e.g., O, F, S, P, or a combination thereof; E may be, e.g., Co, Mn, or a combination thereof; T may be, e.g., F, S, P, or a combination thereof; G may be, e.g., Al, Cr, Mn, Fe, Mg, La, Ce, Sr, V, or a combination thereof; Q may be, e.g., Ti, Mo, Mn, or a combination thereof; Z may be, e.g., Cr, V, Fe, Sc, Y, or a combination thereof; and J may be, e.g., V, Cr, Mn, Co, Ni, Cu, or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. In the coating layer forming process, a suitable method that does not adversely affect the physical properties of the positive active material, e.g., spray coating, dipping, and the like may be used.

In an implementation, the positive active material may include, e.g., a lithium nickel composite oxide represented by Chemical Formula 11.

Liₐ₁₁Niₓ₁₁M¹¹_{y11}M¹²_{1-x11-y12}O₂ [Chemical Formula 11]

In Chemical Formula 11, 0.9≤a11≤1.8, 0.3≤x11≤1, 0≤y11≤0.7, and M¹¹ and M¹² may each independently be Al, B, Ce, Co, Cr, F, Mg, Mn, Mo, Nb, P, S, Si, Sr, Ti, V, W, Zr, or a combination thereof.

In Chemical Formula 11, 0.4≤x11≤1 and 0≤y11≤0.6, 0.5≤x11≤1 and 0≤y11≤0.5, 0.6≤x11≤1 and 0≤y11≤0.4, or 0.7≤x11≤1 and 0≤y11≤0.3, 0.8≤x11≤1 and 0≤y11≤0.2, or 0.9≤x11≤1 and 0≤y11≤0.1.

In an implementation, the positive active material may include a lithium nickel cobalt composite oxide represented by Chemical Formula 12.

Liₐ₁₂Niₓ₁₂Co_{y12}M¹³_{1-x12-y12}O₂ [Chemical Formula 12]

In Chemical Formula 12, 0.9≤a12≤1.8, 0.3≤x12<1, 0<y12≤0.7, and M¹³ may be Al, B, Ce, Cr, F, Mg, Mn, Mo, Nb, P, S, Si, Sr, Ti, V, W, Zr, or a combination thereof.

In Chemical Formula 12, 0.3≤x12≤0.99 and 0.01≤y12≤0.7, 0.4≤x12≤0.99 and 0.01≤y12≤0.6, 0.5≤x12≤0.99 and 0.01≤y12≤0.5, 0.6≤x12<0.99 and 0.01≤y12≤0.4, 0.7≤x12≤0.99 and 0.01≤y12≤0.3, 0.8≤x12≤0.99 and 0.01≤y12≤0.2, or 0.9≤x12≤0.99 and 0.01≤y12<0.1.

In an implementation, the positive active material may include a lithium nickel cobalt composite oxide represented by Chemical Formula 13.

Liₐ₁₃Niₓ₁₃Co_{y13}M¹⁴_{z13}M¹⁵_{1-x13-y13-z13}O₂ [Chemical Formula 3]

In Chemical Formula 13, 0.9≤a13≤1.8, 0.3≤x13≤0.98, 0.01≤y13≤0.69, 0.01≤z13≤0.69, M¹⁴ may be Al, Mn, or a combination thereof, and M¹⁵ may be B, Ce, Cr, F, Mg, Mo, Nb, P, S, Si, Sr, Ti, V, W, Zr, or a combination thereof.

In Chemical Formula 13, 0.4≤x13≤0.98, 0.01≤y13≤0.59, and 0.01≤z13<0.59, 0.5≤x13≤0.98, 0.01≤y13≤0.49, and 0.01≤z≤0.49, or 0.6≤x13≤0.98, 0.01≤y13≤0.39, and 0.01≤z13≤0.39, or 0.7≤x13≤0.98, 0.01y13≤0.29, and 0.01≤z13≤0.29, 0.8≤x13≤0.98, 0.01y13≤0.19, and 0.01≤z13<0.19, or 0.9≤x13≤0.98, 0.01≤y13≤0.09, and 0.01≤z13<0.09.

The content of the positive active material may be about 90 wt % to about 98 wt %, e.g., about 90 wt % to about 95 wt %, based on the total weight of the positive active material layer. The content of the binder and the conductive material may each be about 1 wt % to about 5 wt %, based on the total weight of the positive active material layer.

The binder may help improve binding properties of positive active material particles with one another and with a current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material is included to provide electrode conductivity. Any electrically conductive material may be used as a conductive material unless it causes a chemical change. Examples of the conductive material may include a carbon material such as natural graphite, artificial graphite, carbon black, acetylene black, ketjen black, a carbon fiber, or the like; a metal material of a metal powder or a metal fiber including copper, nickel, aluminum, silver, or the like; a conductive polymer such as a polyphenylene derivative; or a mixture thereof.

In an implementation, an aluminum foil may be used as the positive current collector.

Separator

The separator may separate a positive electrode and a negative electrode and provides a transporting passage for lithium ions and may be a suitable separator for a lithium ion battery. In an implementation, it may have low resistance to ion transport and excellent impregnation for an electrolyte. In an implementation, separator may include a glass fiber, polyester, Teflon, polyethylene, polypropylene, polytetrafluoroethylene, or a combination thereof. It may have a form of a non-woven fabric or a woven fabric. In an implementation, in a lithium ion battery, a polyolefin polymer separator such as polyethylene and polypropylene may be used. In order to ensure the heat resistance or mechanical strength, a coated separator including a ceramic component or a polymer material may be used. In an implementation, it may have a mono-layered or multi-layered structure.

Electrolyte

The electrolyte may include a non-aqueous organic solvent and a lithium salt.

The non-aqueous organic solvent may serve as a medium for transmitting ions taking part in the electrochemical reaction of a battery. The non-aqueous organic solvent may include a carbonate, ester, ether, ketone, alcohol, or aprotic solvent. The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methyl propionate, ethyl propionate, γ-butyrolactone, decanolide, valerolactone, mevalonolactone, caprolactone, or the like. The ether solvent may include dibutyl ether, tetraglyme, diglyme, dimethoxyethane, 2-methyltetrahydrofuran, tetrahydrofuran, or the like. The ketone solvent may include cyclohexanone or the like. The alcohol solvent may include ethyl alcohol, isopropyl alcohol, or the like. The aprotic solvent may include nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, or the like.

The non-aqueous organic solvent may be used alone or in a mixture. When the organic solvent is used in a mixture, a mixture ratio may be controlled in accordance with a desirable battery performance.

In an implementation, in the case of the carbonate solvent, a mixture of a cyclic carbonate and a chain carbonate may be used. In this case, when the cyclic carbonate and the chain carbonate are mixed in a volume ratio of about 1:1 to about 1:9, the electrolyte may exhibit excellent performance.

The non-aqueous organic solvent may further include an aromatic hydrocarbon organic solvent in addition to the carbonate solvent. In this case, the carbonate solvent and the aromatic hydrocarbon organic solvent may be mixed in a volume ratio of about 1:1 to about 30:1.

As the aromatic hydrocarbon solvent, an aromatic hydrocarbon compound represented by Chemical Formula I may be used.

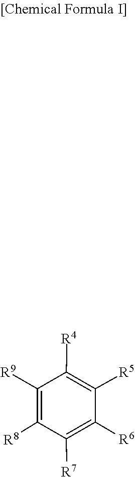

In Chemical Formula I, R⁴ to R⁹ may each independently be hydrogen, a halogen, a C1 to C10 alkyl group, a haloalkyl group, or a combination thereof.

Examples of the aromatic hydrocarbon solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate compound of Chemical Formula II in order to help improve cycle-life of a battery.

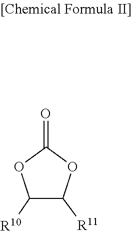

In Chemical Formula II, R¹⁰ and R¹¹ may each independently be, e.g., hydrogen, a halogen, a cyano group, a nitro group, and fluorinated C1 to C5 alkyl group, provided that at least one of R¹⁰ and R¹¹ is selected from a halogen, a cyano group, a nitro group, or a fluorinated C1 to C5 alkyl group, but both of R¹⁰ and R¹¹ are not hydrogen.

Examples of the ethylene carbonate compound may include difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving cycle-life may be used within an appropriate range.

The lithium salt dissolved in the non-organic solvent may supply lithium ions in a battery, may facilitate a basic operation of a rechargeable lithium battery, and may help improve transportation of the lithium ions between positive and negative electrodes.

Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, e.g., an integer ranging from 1 to 20), lithium difluoro(bisoxolato) phosphate, LiCl, LiI, LiB(C₂O₄)₂ (lithium bis(oxalato) borate; LiBOB), and lithium difluoro(oxalato)borate (LiDFOB).

The lithium salt may be used in a concentration ranging from about 0.1 M to about 2.0 M. When the lithium salt is included at the above concentration range, an electrolyte may have excellent performance and lithium ion mobility due to optimal electrolyte conductivity and viscosity.

Rechargeable lithium batteries may include, e.g., lithium ion batteries, lithium ion polymer batteries, and lithium polymer batteries, according to the presence of a separator and the type of electrolyte used therein. The rechargeable lithium batteries may have a variety of shapes and sizes, and include cylindrical, prismatic, coin, or pouch batteries, and may be thin film batteries or may be rather bulky in size.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

[Internal Pores of Negative Active Material Composite]

### EXAMPLE 1

(1) Preparation of Negative Active Material Composite

As a solvent, a mixed solvent including IPA and EtOH in a volume ratio of 3:7 was prepared. To 80 g of the mixed solvent, 5 g of silicon nanoparticles (D50: 100 nm) and 5 g of SiO particles (D50: 3 μm) of Table 1 were added and then, dispersed therein. Accordingly, a solution in which the silicon nanoparticles and the SiO particles were uniformly dispersed in the mixed solvent was obtained.

The solution was spray-dried at 150° C. and a spray rate of 60 g/min by using a spray drier.

6 g of the obtained product of the spray-drying was mixed with 6 g of petroleum-based pitch, which is a type of amorphous carbon, and this mixture was compression-molded under a pressure of 20 Mpa for 3 minutes.

The obtained compression-molded product was heat-treated at 1,000° C. under an N₂ atmosphere, preparing a negative active material composite.

(2) Manufacture of Negative Electrode

A negative active material slurry was prepared by mixing 70 wt % of the negative active material composite, 15 wt % of a conductive material (Super-P), and 15 wt % of a binder (polyacrylic acid (PAA)) in water as a solvent. The negative active material slurry was coated on one surface of a copper foil with a width of 76.5 mm, a length of 48.0 mm, and a thickness of 10 μm and then, dried and compressed, manufacturing a negative electrode. Herein, the negative active material slurry was coated in a die coating method.

(3) Manufacture of Positive Electrode

A positive active material slurry was prepared by mixing 95 wt % of LiCoO2 as a positive active material, 3 wt % of polyvinylidene fluoride as a binder, and 2 wt % of ketjen black as a conductive material in an N-methylpyrrolidone solvent. The positive active material slurry was coated on one surface of an aluminum current collector with a width of 74.5 mm, a length of 45.0 mm, and a thickness of 12 μm and then, dried and compressed, manufacturing a negative electrode. Herein, the positive active material slurry was coated in the die coating method.

(4) Manufacture of Battery Cell

A polyethylene separator with a width of 76.5 mm, a length of 48.0 mm, and a thickness of 14 μm was prepared and then, inserted between the negative electrode and the positive electrode and then, assembled together. Herein, the coating surface of the negative electrode was in contact with the separator.

The electrode assembly was housed in a pouch, and an electrolyte solution (including 10% of FEC in a 1.10 M LiPF₆ solution in a mixed solvent of ethylene carbonate and diethyl carbonate in a volume ratio of 50:50) was injected thereinto, manufacturing a rechargeable lithium battery cell.

### EXAMPLE 2

A negative active material composite was prepared in the same manner as in Example 1 except for changing the compression-molding pressure to 30 Mpa. Subsequently, a negative electrode and a rechargeable lithium battery cell of Example 2 were manufactured in the same manner as in Example 1 except for using this negative active material composite.

### EXAMPLE 3

A negative active material composite was prepared in the same manner as in Example 1 except for changing the compression-molding pressure to 50 Mpa. Subsequently, a negative electrode and a rechargeable lithium battery cell of Example 3 were manufactured in the same manner as in Example 1 except for using this negative active material composite.

### EXAMPLE 4

A negative active material composite of Example 4 was prepared in the same manner as in Example 1 except for changing the compression-molding pressure to 100 Mpa. Subsequently, a negative electrode and a rechargeable lithium battery cell of Example 4 were manufactured in the same manner as in Example 1 except for using this negative active material composite.

### Comparative Example 1

5 g of SiO particles (D50: 3.0 μm) and 5 g of SiC particles (D50: 8.4 μM) were mixed to prepare a negative active material of Comparative Example 1. A negative electrode and a rechargeable lithium battery cell of Comparative Example 1 were manufactured in the same manner as in Example 1 except for using this negative active material composite.

### Comparative Example 2

A negative active material composite of Comparative Example 2 was prepared in the same manner as in Example 1 except for changing the compression-molding pressure to 1 Mpa. Subsequently, a negative electrode and a rechargeable lithium battery cell of Comparative Example 2 were manufactured in the same manner as in Example 1 except for using this negative active material composite.

### Comparative Example 3

A negative active material composite of Comparative Example 3 was prepared in the same manner as in Example 1 except for changing the compression-molding pressure to 10 Mpa. Subsequently, a negative electrode and a rechargeable lithium battery cell of Comparative Example 3 were manufactured in the same manner as in Example 1 except for using this negative active material composite.

TABLE 1

| | | Si nanoparticle SPEC | | | |
|---|---|---|---|---|---|
| | | | | | XRD full |
| | Type of negative | | D50 | Aspect | width at half |
| | active material | Shape | (nm) | ratio | maximum (°) |
| Comparative | SiO:SiC = 5:5 | — | — | — | — |
| Example 1 | (blending) | | | | |
| Comparative | SiO@SiC | flake | 100 | 4-20 | 0.61 |
| Example 2 | | | | | |
| Comparative | SiO@SiC | flake | 100 | 4-20 | 0.61 |
| Example 3 | | | | | |
| Example 1 | SiO@SiC | flake | 100 | 4-20 | 0.61 |
| Example 2 | SiO@SiC | flake | 100 | 4-20 | 0.61 |
| Example 3 | SiO@SiC | flake | 100 | 4-20 | 0.61 |
| Example 4 | SiO@SiC | flake | 100 | 4-20 | 0.61 |

Specifically, the negative active material composites with a SiO@SiC structure according to Examples 1 to 4 and Comparative Examples 2 and 3 were prepared by using the same raw materials, e.g., silicon nanoparticles and the like, but varying the compression-molding pressure, respectively. On the other hand, Comparative Example 1 used a simple mixture of the SiO particles and the SiC particles.

### Evaluation Example 1

### Evaluation of Properties of Negative Active Material Composite

Each negative active material composite according to Examples 1 to 4 and Comparative Examples 1 to 3 were evaluated in the following method, and the results are shown in Table 2.

(1) Internal pore volume and BET specific surface area: A volume of internal pores was quantitatively measured by using BJH (Barrett-Joyner-Halenda) analysis equipment.

Each electrode plate portion of the unreacted regions of the rechargeable lithium battery cells which were charged and discharged at 0.1 C one time was taken and put into a pore-measuring device (equipment name: ASAP series, manufacturer: Micromeritics Instrument Corp.) and then, heated at 10 K/min to 623 K and maintained for 2 hours to 10 hours (vacuum: 100 mmHg or less) for a pretreatment. Herein, the temperature and the time may be appropriately adjusted according to negative active material composite powder.

Subsequently, a pore volume was measured in liquid nitrogen controlled to have a relative pressure (P/Pₒ) of 0.01 or less. Specifically, the pore volume was measured by absorbing nitrogen under the relative pressure of 0.01 to 0.995 at 32 points and then, desorbing the nitrogen under the relative pressure to 0.14 at 24 points. Herein, the pore volume may be in general measured to the relative pressure (P/Pₒ) of 0.1 with BET.

(2) D50: An average particle diameter (D50) of the negative active material composites was measured by using PSA (particle size analyzer, Beckman Coulter, Inc.).

TABLE 2

| | | Negative active material | | |
|---|---|---|---|---|
| | | composite SPEC | | |
| | | Internal | BET specific | |
| | Type of negative | pore volume | surface area | D50 |
| | active material | (cm³/g) | (cm²/g) | (μm) |
| Comparative | SiO:SiC = 5:5 | 0.022 | 2.1 | SiO: 3.0 |
| Example 1 | (blending) | | | SiC: 8.4 |
| Comparative | SiO@SiC | 0.154 | 3.4 | 8.5 |
| Example 2 | | | | |
| Comparative | SiO@SiC | 0.081 | 2.8 | 8.4 |
| Example 3 | | | | |
| Example 1 | SiO@SiC | 0.050 | 2.3 | 8.4 |
| Example 2 | SiO@SiC | 0.022 | 2.2 | 8.3 |
| Example 3 | SiO@SiC | 0.005 | 1.9 | 8.6 |
| Example 4 | SiO@SiC | 0.001 | 2.1 | 8.5 |

In Table 2, unlike the negative active material composites according to Comparative Examples 2 and 3, the negative active material composites of Examples 1 to 4 exhibited an internal pore volume of 5.0×10⁻² cm³/g or less, and greater than 0 cm³/g. Specifically, referring to Examples 1 to 4 and Comparative Examples 2 and 3, an internal pore volume and a BET specific surface area of the negative active material composites varied according to the compression-molding pressure. More specifically, when the compression-molding pressure was set to be greater than 10 Mpa and particularly, 20 Mpa or more, the negative active material composites secured an internal pore volume of 5.0×10⁻² cm³/g or less, and greater than 0 cm³/g. In addition, as the compression-molding pressure increased, e.g., 20 Mpa or more, the internal pore volume and the BET specific surface area of the negative active material composites tended to decrease.

On the other hand, Comparative Example 1 used the simple mixture of SiO particles and SiC particles, and each particle had an average internal pore size of 5.0×10⁻² cm³/g or less and greater than about 0 cm3/g.

### Evaluation Example 2

### Evaluation of Electrochemical Characteristics of Rechargeable Lithium Battery Cells

Each rechargeable lithium battery cell of Examples 1 to 4 and Comparative Examples 1 to 3 was evaluated with respect to electrochemical characteristics in the following method, and the results are shown in Table 3.

(1) Initial efficiency: The rechargeable lithium battery cells were charged and discharged at 0.1 C once and then evaluated with respect to initial charge and discharge efficiency, and the results are shown in Table 3.

(2) Cycle-life characteristics: The rechargeable lithium battery cells were charged and discharged at 0.5 C at 25° C. 100 times. A ratio of discharge capacity at the first cycle to discharge capacity at the 100^{th} cycle was calculated, and the results are shown in Table 3.

TABLE 3

| | | Rechargeable lithium battery cell SPEC | |
|---|---|---|---|
| | Type of negative | Initial efficiency | Cycle-life |
| | active material | (F.C.E, %) | (@100 cyc) |
| Comparative | SiO:SiC = 5:5 | 85.1 | 60 |
| Example 1 | (blending) | | |
| Comparative | SiO@SiC | 86.1 | 67 |
| Example 2 | | | |
| Comparative | SiO@SiC | 86.7 | 71 |
| Example 3 | | | |
| Example 1 | SiO@SiC | 87.3 | 83 |
| Example 2 | SiO@SiC | 87.4 | 84 |
| Example 3 | SiO@SiC | 87.4 | 85 |
| Example 4 | SiO@SiC | 87.5 | 84 |

In Table 3, unlike the rechargeable lithium battery cells manufactured by using the negative active material mixture of Comparative Example 1 and the negative active material composites of Comparative Example 2 and 3, the rechargeable lithium battery cells manufactured by using the negative active material composites of Examples 1 to 4 maintained 80% or more of discharge capacity after 100 cycles. Comparative Example 1 using the simple mixture of SiO particles and SiC particles exhibited an average internal pore of each particles in a range of 5.0×10⁻² cm³/g or less and greater than 0 cm³/g, but failed in overcoming a drawback of the SiC particles, resulting in deteriorating cycle-life of the rechargeable lithium battery cell.

Each of the negative active material composites according to Examples 1 to 4 and Comparative Examples 2 and 3, which was a composite including compound particles represented by SiOₓ (0<x≤2.0), silicon nanoparticles, and amorphous carbon, improved a cycle-life of the rechargeable lithium battery cells, compared with the negative active material mixture of Comparative Example 1.

However, each negative active material composite of Comparative Examples 2 and 3 had an internal pore volume of greater than 5.0×10⁻² cm³/g, and maintained about 70% of discharge capacity of the rechargeable lithium battery cells after the 100 cycles.

On the contrary, each negative active material composite of Examples 1 to 4 exhibited an internal pore volume of 5.0×10⁻² cm³/g or less and greater than 0 cm³/g, and secured 80% or more of discharge capacity of the rechargeable lithium battery cells even after the 100 cycles.

Accordingly, in order to improve cycle-life as well as initial efficiency of the rechargeable lithium battery cells, a negative active material which is a composite including the compound particles represented by SiOₓ (0<x≤2.0), silicon nanoparticles, and amorphous carbon and has an internal pore volume of 5.0×10⁻² cm³/g or less, and greater than about 0 cm³/g, may be used.

[D50 Particle Diameter of Silicon Nanoparticles]

### EXAMPLE 5

A negative active material composite of Example 5 was prepared by using silicon nanoparticles under the conditions described in Table 4. A negative electrode and a rechargeable lithium battery cell of Example 5 were manufactured in the same manner as in Example 2 except that the negative active material composite of Example 5 was used.

### EXAMPLE 6

A negative active material composite of Example 6 was prepared by using silicon nanoparticles under the conditions described in Table 4. A negative electrode and a rechargeable lithium battery cell of Example 6 were manufactured in the same manner as in Example 2 except that the negative active material composite of Example 6 was used.

### EXAMPLE 7

A negative active material composite of Example 7 was prepared by using silicon nanoparticles under the conditions described in Table 4. A negative electrode and a rechargeable lithium battery cell of Example 7 were manufactured in the same manner as in Example 2 except that the negative active material composite of Example 7 was used.

### Comparative Example 4

A negative active material composite of Comparative Example 4 was prepared by using silicon nanoparticles under the conditions described in Table 4. A negative electrode and a rechargeable lithium battery cell of Comparative Example 4 were manufactured in the same manner as in Example 2 except that the negative active material composite of Comparative Example 4 was used.

### Comparative Example 5

A negative active material composite of Comparative Example 5 was prepared by using silicon nanoparticles under the conditions described in Table 4. A negative electrode and a rechargeable lithium battery cell of Comparative Example 5 were manufactured in the same manner as in Example 2 except that the negative active material composite of Comparative Example 5 was used.

TABLE 4

| | | Si nanoparticle SPEC | | | |
|---|---|---|---|---|---|
| | | | | | XRD full |
| | Type of negative | | D50 | Aspect | width at half |
| | active material | Shape | (nm) | ratio | maximum (°) |
| Comparative | SiO@SiC | flake | 300 | 4-20 | 0.22 |
| Example 4 | | | | | |
| Comparative | SiO@SiC | flake | 250 | 4-20 | 0.25 |
| Example 5 | | | | | |
| Example 5 | SiO@SiC | flake | 200 | 4-20 | 0.30 |
| Example 6 | SiO@SiC | flake | 150 | 4-20 | 0.38 |
| Example 2 | SiO@SiC | flake | 100 | 4-20 | 0.61 |
| Example 7 | SiO@SiC | flake | 50 | 4-20 | 1.05 |

Specifically, in Examples 2 and 5 to 7 and Comparative Examples 4 and 5, the negative active material composites with a SiO@SiC structure were prepared under the same compression-molding pressure but varied a D50 particle diameter and an XRD full width at half maximum of the silicon nanoparticles.

### Evaluation Example 3

### Evaluation of Properties of Negative Active Material Composite

Each of the negative active material composites according to Examples 2 and 5 to 7 and Comparative Examples 4 and 5 was evaluated in the same method as in Evaluation Example 1, and the evaluation results are shown in Table 5.

TABLE 5

| | | Negative active material SPEC | | |
|---|---|---|---|---|
| | | | BET specific | |
| | Type of negative | Internal pore | surface area | D50 |
| | active material | volume (cm³/g) | (cm²/g) | (μm) |
| Comparative | SiO@SiC | 0.023 | 2.2 | 8.4 |
| Example 4 | | | | |
| Comparative | SiO@SiC | 0.024 | 2.1 | 8.5 |
| Example 5 | | | | |
| Example 5 | SiO@SiC | 0.025 | 2.2 | 8.4 |
| Example 6 | SiO@SiC | 0.024 | 2.3 | 8.3 |
| Example 2 | SiO@SiC | 0.022 | 2.2 | 8.3 |
| Example 7 | SiO@SiC | 0.022 | 2.1 | 8.4 |

In Table 5, each of the negative active material composites of Examples 2 and 5 to 9 and Comparative Example 4 and 5 exhibited almost equal internal pore volumes. Accordingly, it may be seen that the internal pore volumes of the negative active material composites turned out to more depend on the compression-molding pressure than the D50 particle diameter of the silicon nanoparticles.

### Evaluation Example 4

### Evaluation of Electrochemical Characteristics of Rechargeable Lithium Battery Cells

Each of the rechargeable lithium battery cells of Examples 2 and 5 to 7 were evaluated with respect to electrochemical characteristics in the same method as in Evaluation Example 2, and the results are shown in Table 6.

TABLE 6

| | | Rechargeable lithium battery cell SPEC | |
|---|---|---|---|
| | Type of negative | Initial efficiency | Cycle-life |
| | active material | (F.C.E, %) | (@100 cycles) |
| Comparative | SiO@SiC | 87.9 | 62 |
| Example 4 | | | |
| Comparative | SiO@SiC | 87.6 | 68 |
| Example 5 | | | |
| Example 5 | SiO@SiC | 87.4 | 82 |
| Example 6 | SiO@SiC | 87.5 | 84 |
| Example 2 | SiO@SiC | 87.4 | 84 |
| Example 7 | SiO@SiC | 87.3 | 85 |

In Table 6, the rechargeable lithium battery cells manufactured by using each of the negative active material composites of Examples 2 and 5 to 7, but Comparative Examples 4 and 5 exhibited almost equal initial efficiency but different cycle-life characteristics. Specifically, each of the negative active material composites of Examples 2 and 5 to 7 and Comparative Examples 4 and 5 exhibited an internal pore volume of 5.0×10⁻² cm³/g or less and greater than 0 cm³/g, regardless of a D50 particle diameter of the silicon nanoparticles, and secured 87% or more of initial efficiency of the rechargeable lithium battery cells.

However, each of the negative active material composites of Comparative Examples 4 and 5 used silicon nanoparticles with a D50 particle diameter of greater than 200 nm and maintained less than 70% of discharge capacity of the rechargeable lithium battery cells even after 100 cycles.

Accordingly, in order to improve a cycle-life as well as initial efficiency of the rechargeable lithium battery cells, a negative active material, which is a composite including compound particles represented by SiOₓ (0<x≤2.0), silicon nanoparticles, and amorphous carbon, wherein the silicon nanoparticles had a D50 particle diameter of 200 nm or less and greater than 0 nm, having an internal pore volume of 5.0×10⁻² cm³/g or less and greater than 0 cm³/g, may be used.

By way of summation and review, a non-carbon negative active material may have a large volume change due to charging and discharging, and thus cycle-life of the rechargeable lithium battery could be shortened, compared to the carbon negative active material.

One or more embodiments may provide a negative active material composite capable of simultaneously securing initial efficiency, cycle-life, or the like of a rechargeable lithium battery including the negative active material composite.

The negative active material composite of an embodiment may implement a rechargeable lithium battery that exhibits excellent initial efficiency, cycle-life, and the like.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material composite for a rechargeable lithium battery, the negative active material composite comprising:
compound particles represented by SiOₓ, in which 0<x≤2.0;
silicon nanoparticles having an average particle diameter (D50) of greater than 0 nm and less than or equal to about 200 nm; and
amorphous carbon,
wherein an internal pore volume of the negative active material composite is greater than 0 cm³/g and less than or equal to about 5.0×10⁻² cm³/g.

2. The negative active material composite as claimed in claim 1, wherein the average particle diameter (D50) of the silicon nanoparticles is about 50 nm to about 200 nm.

3. The negative active material composite as claimed in claim 1, wherein an aspect ratio of the silicon nanoparticles is about 4 to about 20.

4. The negative active material composite as claimed in claim 1, wherein a full width at half maximum of an X-ray diffraction angle (2θ) using CuKα ray at the (111) plane of the silicon nanoparticles is about 0.3° to about 1.5°.

5. The negative active material composite as claimed in claim 1, wherein an average particle diameter (D50) of the compound particles is about 1 μm to about 10 μm.

6. The negative active material composite as claimed in claim 1, wherein the amorphous carbon includes soft carbon, hard carbon, a mesophase pitch carbonized product, calcined coke, or a combination thereof.

7. The negative active material composite as claimed in claim 1, wherein the composite includes the compound particles and the silicon nanoparticles in a weight ratio of about 8:2 to about 2:8.

8. The negative active material composite as claimed in claim 1, wherein the negative active material composite includes:
the compound particles in an amount of about 5 wt % to about 90 wt %,
the silicon nanoparticles in an amount of about 10 wt % to about 95 wt %, and
a balance amount of the amorphous carbon, all wt % being based on a total weight of the negative active material composite.

9. The negative active material composite as claimed in claim 1, wherein an average particle diameter (D50) of the negative active material composite is about 2 μm to about 15 μm.

10. The negative active material composite as claimed in claim 1, wherein an internal pore diameter of the negative active material composite is greater than 0 nm and less than or equal to about 330 nm.

11. The negative active material composite as claimed in claim 1, wherein a BET specific surface area of the negative active material composite is about 0.1 m²/g to about 10 m²/g.

12. The negative active material composite as claimed in claim 1, wherein:
the negative active material composite includes a matrix including the silicon nanoparticles and the amorphous carbon; and
the compound particles are in the matrix.

13. The negative active material composite as claimed in claim 12, wherein the matrix includes:
secondary particles in which the silicon nanoparticles are aggregated; and
a coating layer surrounding the outer surface of the secondary particle and the outer surface of the silicon nanoparticles and including the amorphous carbon.

14. A method of preparing the negative active material composite for a rechargeable lithium battery as claimed in claim 1, the method comprising:
spray-drying a solution including a solvent, the compound particles represented by SiOₓ, in which 0<x≤2.0, and the silicon nanoparticles;
compression-molding a mixture including the obtained product of the spray-drying and the amorphous carbon precursor at a pressure of greater than about 10 Mpa; and
heat-treating the obtained product of the compression-molding to obtain the negative active material composite.

15. The method as claimed in claim 14, wherein the spray-drying is performed at a temperature of about 120° C. to about 170° C.

16. The method as claimed in claim 14, wherein the compression-molding is performed at a pressure of greater than about 10 MPa less or equal to about 150 MPa.

17. The method as claimed in claim 14, wherein the heat-treating is performed at a temperature of about 700° C. to about 1,100° C.

18. A negative electrode for a rechargeable lithium battery, the negative electrode comprising:
a current collector; and
a negative active material layer on the current collector,
wherein the negative active material layer includes the negative active material composite as claimed in claim 1.

19. The negative electrode as claimed in claim 18, wherein the negative active material layer further includes a conductive material, a binder, or a combination thereof.

20. A rechargeable lithium battery, comprising:
a positive electrode;
a negative electrode; and
an electrolyte,
wherein the negative electrode is the negative electrode as claimed in claim 18.
